(19) United States
(12) Patent Application Publication
(10) Pub. No.: US 2016/0272529 A1
(43) Pub. Date: Sep. 22, 2016

(54) GLASS SUBSTRATE FORMING APPARATUS

(71) Applicant: CORNING PRECISION MATERIALS CO., LTD., Asan-si, Chungcheongnam-do (KR)

(72) Inventors: Jae Seon Hong, Chungcheongnam-do (KR); Jong Hwa Kim, Chungcheongnam-do (KR); Kyu Bong Chae, Chungcheongnam-do (KR); Myung Hwan Kim, Chungcheongnam-do (KR); Duck Kyo Seo, Chungcheongnam-do (KR)

(73) Assignee: Corning Precision Materials Co., Ltd., Chungcheongnam-do (KR)

(21) Appl. No.: 15/034,095

(22) PCT Filed: Nov. 4, 2014
(86) PCT No.: PCT/KR2014/010477

§ 371 Date: May 3, 2016

(30) Foreign Application Priority Data
Nov. 4, 2013 (KR) 10-2013-0132949

(51) Int. Cl. C03B 23/035

(52) U.S. Cl. CPC C03B 23/0357

(57) ABSTRACT

The present invention relates to a glass substrate forming apparatus and, more particularly, to a glass substrate forming apparatus that can form a three-dimensionally-shaped glass substrate having various curved surfaces and curvatures without restrictions in terms of the number of curved surfaces and the sizes of the curvatures of the curved surfaces—that is, a three-dimensional glass substrate having at least one side of four sides formed in a curvature and having one of various designs. To this end, the present invention provides a glass substrate forming apparatus characterized by comprising: a molding frame; a forming recess formed in one surface of the molding frame; a plurality of vacuum holes formed in the molding frame and communicating with the forming recess; and a vacuum unit connected to the plurality of vacuum holes, wherein a plurality of vacuum holes are formed into groups for the respective regions of the forming recess and are divided into a plurality of vacuum hole groups, and when individually connected with each of the plurality of vacuum hole groups to form a glass substrate, the vacuum unit sequentially applies vacuum pressure for each region of the glass substrate.

### BACKGROUND OF THE INVENTION

1. Field of the Invention

The present invention relates to an apparatus for shaping a glass substrate, and more particularly, to an apparatus for shaping a glass substrate able to shape a glass substrate to have a variety of three-dimensional (3D) shapes, in which neither the number of curved surfaces nor the size of the curvature of the curved surfaces is restricted, i.e. a variety of 3D designs in which at least one edge portion from among the four edges of the glass substrate is a curved surface.

2. Description of Related Art

Glass products are used in a variety of fields. For example, mobile phones use a cover glass to protect a touchscreen glass. Recently, products, the design of which can be varied using cover glasses having unique shapes according to final makers, are gaining increasing interest.

Cover glasses that have been used for mobile phones of the related art have a flat shape or curved corners. However, in response to the various functions and designs of mobile phones, curved glasses in which a pair of opposing edges from among the four edges is curved are currently being used for mobile phones.

A method of fabricating such a cover glass includes: preparing a mold having a shaping recess with a plurality of shaping holes formed on the bottom of the shaping recess; disposing the mold on a heated glass substrate; and applying vacuum, i.e. a force of drawing the glass substrate to the plurality of shaping holes, to the glass substrate through the plurality of shaping holes, thereby shaping the glass substrate to have the shape of the shaping recess.

However, this shaping method of the related art is devised to shape a glass substrate by simultaneously applying a vacuum pressure to the entire glass substrate through a plurality of vacuum holes. This method can only shape the glass substrate according to the shape of a shaping recess. When there is a change in the design of a cover glass to be manufactured changes, for example, the number of curved surfaces or the size of the curvature of curved surfaces, the mold must be substituted with a new mold in order to respond to the change in the design. This, however, decreases the process efficiency and increases a manufacturing cost.

### RELATED ART DOCUMENT

Patent Document 1: Korean Patent No. 10-0701653 (Mar. 23, 2007)

### BRIEF SUMMARY OF THE INVENTION

Various aspects of the present invention provide an apparatus for shaping a glass substrate able to shape a glass substrate to have a variety of three-dimensional (3D) shapes, in which neither the number of curved surfaces nor the size of the curvature of the curved surfaces is restricted, i.e. a variety of 3D designs in which at least one edge portion of the four edges of the glass substrate is a curved surface.

In an aspect of the present invention, provided is an apparatus for shaping a glass substrate that includes: a shaping frame; a shaping recess disposed on one surface of the shaping frame; a plurality of vacuum holes formed in the shaping frame to communicate with the shaping recess; and a vacuum unit connected to the plurality of vacuum holes. The plurality of vacuum holes is divided into a plurality of vacuum hole groups corresponding to a plurality of areas of the shaping recess respectively. The vacuum unit is independently connected to each of the plurality of vacuum hole groups to sequentially apply a vacuum pressure to each of a plurality of areas of the glass substrate when shaping the glass substrate.

According to an embodiment of the present invention, a common path may be formed in the shaping frame may, a common path communicating with the plurality of vacuum holes. A partition may be disposed in the common path to divide the plurality of vacuum hole groups from each other.

At least one wall surface of the shaping recess may be formed as a curved surface such that at least one edge portion of four edges of the glass substrate is shaped to a curved surface.

The plurality of vacuum hole groups may include a first vacuum hole group connected to the bottom of the shaping recess and a second vacuum hole group connected to at least one wall surface of the shaping recess

In this case, the vacuum unit may perform first shaping on the glass substrate by applying a vacuum pressure to one area of the glass substrate that is to be a planar surface after being shaped through the first vacuum hole group, and subsequently, second shaping on the glass substrate by applying a vacuum pressure on another area of the glass substrate that is to form a curved surface after being shaped through the second vacuum hole group.

According to the present invention as set forth above, a plurality of vacuum holes formed at positions corresponding to a plurality of areas of a glass substrate that is to have a 3D shape after being shaped is divided into a plurality of vacuum hole groups. It is possible to shape the plurality of areas of the glass substrate corresponding to the vacuum hole groups by sequentially applying a vacuum pressure to the glass substrate through the vacuum hole groups, thereby shaping the glass substrate to have a variety of 3D shapes, in which in which neither the number of curved surfaces nor the size of the curvature of the curved surfaces is restricted.

That is, according to the present invention, it is possible to shape a glass substrate to have a 3D shape according to a variety of 3D designs in which at least one edge portion of the four edges of the glass substrate is a curved surface.

### BRIEF DESCRIPTION OF THE DRAWINGS

FIG. 1 and FIG. 2 are fragmentary perspective view illustrating an apparatus for shaping a glass substrate according to an exemplary embodiment of the present invention.

### DETAILED DESCRIPTION OF THE INVENTION

Reference will now be made in detail to an apparatus for shaping a glass substrate according to the present invention, embodiments of which are illustrated in the accompanying drawings and described below, so that a person skilled in the art to which the present invention relates could easily put the present invention into practice.

Throughout this document, reference should be made to the drawings, in which the same reference numerals and signs are used throughout the different drawings to designate the same or similar components. In the following description of the present invention, detailed descriptions of known functions and components incorporated herein will be omitted in the case that the subject matter of the present invention is rendered unclear.

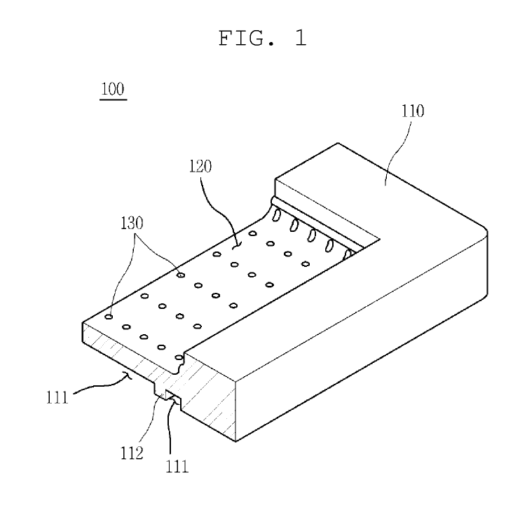

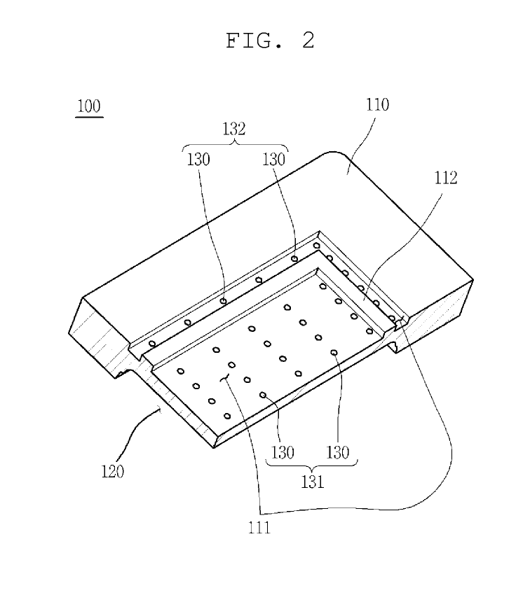

FIG. 1 and FIG. 2 are fragmentary perspective view illustrating an apparatus for shaping a glass substrate according to an exemplary embodiment of the present invention.

As illustrated in FIG. 1 and FIG. 2, an apparatus for shaping a glass substrate 100 according to an embodiment of the present invention is an apparatus able to shape a glass substrate (not shown) to have a three-dimensional (3D) shape, i.e. shape at least one edge portion of the four edges of a flat glass substrate (not shown) to have a curved surface, by vacuum shaping. Here, the term “vacuum shaping” refers to a method of shaping a glass substrate (not shown) by aligning the glass substrate (not shown) heated to a shapeable temperature on a shaping mold and subsequently bringing the glass substrate (not shown) into close contact with the shaping mold by applying a vacuum pressure to the glass substrate (not shown).

That is, the apparatus for shaping a glass substrate 100 according to an embodiment of the present invention is an apparatus for shaping a two-dimensional flat glass substrate (not shown) to have a three-dimensional (3D) curved surface by vacuum shaping.

For this, the apparatus for shaping a glass substrate 100 according to an embodiment of the present invention includes a shaping frame 110, a shaping recess 120, vacuum holes 130 and a vacuum unit (not shown).

The shaping frame 110 defines the outer shape of the apparatus for shaping a glass substrate 100. For example, the shaping frame 110 can have an overall box-shaped structure. The shaping frame 110 may be formed of a material having superior resistance to abrasion, impacts and heat, such as carbon steel, alloy steel or stainless steel.

The shaping recess 120 is formed on one side of the shaping frame 110. More specifically, the shaping recess 120 is formed inward from one surface of the shaping frame 110 that faces a glass substrate (not shown) to be shaped when the glass substrate (not shown) is aligned thereon. Here, at least one wall surface of the shaping recess 120 that determines the shape of the glass substrate (not shown) is formed as a curved surface, since the apparatus for shaping a glass substrate 100 according an embodiment of the present invention serves to shape the glass substrate (not shown) such that the glass substrate (not shown) has a 3D shape, i.e. at least one edge portion of the four edges of the glass substrate (not shown) has a curved surface. In addition, the width of the shaping recess 120 is smaller than that of the glass substrate (not shown) in order to impart a 3D shape, such as a curved surface, to the glass substrate (not shown).

The vacuum holes 130 are formed in the shaping frame 110. One end of each vacuum hole 130 is opened at the bottom of the shaping recess 120 such that the vacuum hole 130 communicates with the shaping recess 120. Each of the vacuum holes 130 is connected to the vacuum unit (not shown), and serves as a path through which a vacuum pressure generated from the vacuum unit (not shown) is transferred to the glass substrate (not shown) aligned on the shaping recess 120. When the glass substrate (not shown) is being shaped, the vacuum pressure, i.e. a force of drawing the glass substrate (not shown) toward the shaping recess 120, is applied to the glass substrate (not shown) through the vacuum holes 130, thereby shaping the glass substrate (not shown) to have the shape of the shaping recess 120.

The vacuum unit (not shown) is connected to a plurality of vacuum holes 130, and serves to apply the vacuum pressure to the glass substrate (not shown) through the plurality of vacuum holes 130. The vacuum unit (not shown) can be implemented as a vacuum pump.

The vacuum holes 130 may be in the shape of cylinders. A preset number of vacuum holes 130 may be formed to apply the vacuum pressure generated from the vacuum unit (not shown) over the entire surface area of the glass substrate (not shown). As illustrated in the figures, the plurality of vacuum holes 130 may be aligned and arranged in columns and rows in order to uniformly distribute the vacuum pressure generated from the vacuum unit (not shown).

According to an embodiment of the present invention, the plurality of vacuum holes 130 is divided into a plurality of vacuum hole groups according to the areas of the shaping recess 120. In addition, the vacuum unit (not shown) is independently connected to each of the plurality of vacuum hole groups. This configuration makes it possible to sequentially apply a vacuum pressure to the areas of the glass substrate (not shown) when shaping the glass substrate (not shown).

More specifically, according to an embodiment of the present invention, the shaping frame 110 has defined therein a common path 111 connected to the vacuum unit 111. The plurality of vacuum holes 130 are connected together via the common path 111. The plurality of vacuum holes 130 is connected to the vacuum unit (not shown) by means of the common path 111. A partition 112 is disposed in the common path 111, and divides the plurality of vacuum holes 130 according to the areas in order to divide the plurality of vacuum holes 130 into the plurality of vacuum hole groups according to the areas of the shaping recess 120. This partition 112 divides the plurality of vacuum holes 130 into the plurality of vacuum hole groups according to the areas of the shaping recess 120.

For example, as illustrated in the figures, the plurality of vacuum hole groups includes a first vacuum hole group 131 and a second vacuum hole group 132. The first vacuum hole group 131 is a first plurality of vacuum holes 130 from among the plurality of vacuum holes 130 that is connected to the bottom of the shaping recess 120. The second vacuum hole group 132 is a second plurality of vacuum holes 130 from among the plurality of vacuum holes 130 that is connected to at least one wall surface of the shaping recess 120. However, this is merely an illustrative example. It is rather possible to divide the shaping recess 120 into more areas and the plurality of vacuum holes 130 into a greater number of vacuum hole groups.

A description will be given below of the operation of the apparatus for shaping a glass substrate according to an embodiment of the present invention.

When a glass substrate (not shown) heated to a shapeable temperature is aligned on the shaping recess 120 formed on the shaping frame 110, first shaping is performed on the glass substrate (not shown) in order to shape one area of the glass substrate (not shown) that is to be a planar surface after being shaped. The first shaping is performed by applying a vacuum pressure to one area of the glass substrate (not shown) through the first vacuum hole group 131 consisting of the first plurality of vacuum holes 130 that faces one area of the glass substrate (not shown). Consequently, the glass substrate (not shown) is brought into close contact with the bottom of the shaping recess 120 in which the first vacuum hole group 131 is disposed, and an edge portion of the glass substrate (not shown) bent due to the shape of the shaping recess 120 is spaced apart from the wall surface of the shaping recess 120.

Afterwards, second shaping is performed on the glass substrate (not shown) in order to shape the other area of the glass substrate (not shown) that is to form a curved surface after being shaped, i.e. the edge portion of the glass substrate (not shown) bent at the first shaping. The second shaping is performed by applying a vacuum pressure to the edge portion of the glass substrate (not shown) through the second vacuum hole group 132 consisting of the second plurality of vacuum holes 130 that faces the edge portion of the glass substrate (not shown). At the second shaping, the vacuum unit (not shown) continuously applies the vacuum pressure to one area of the glass substrate (not shown) through the first vacuum hole group 131 so that one area of the glass substrate (not shown) stays in close contact with the bottom of the shaping recess 120. Consequently, the second shaping can be more reliably performed, i.e. the edge portion of the glass substrate (not shown) can be more reliably shaped to a curved surface.

In order to more precisely shape the glass substrate (not shown) to have a 3D shape, for example, the second vacuum hole group 132 that adjoins to the edge portion of the glass substrate (not shown) may be divided into a plurality of vacuum hole groups. Accordingly, the process of shaping the glass substrate (not shown) may also include third, fourth and subsequent steps.

In addition, although the vacuum holes 130 of the second vacuum hole group 132 according to an embodiment of the present invention are arranged in a line, these vacuum holes 130 can be arranged in two or three lines, each of which forms one separate vacuum hole group, in order to more precisely shape the glass substrate (not shown) to have a 3D shape. Since the vacuum unit (not shown) according to an embodiment of the present invention is connected to the vacuum holes such that it can separately control the vacuum hole groups, it is possible to adjust the sequence of the glass substrate areas to be shaped by controlling each of the vacuum hole groups according to the design of the glass substrate (not shown) to be shaped. It is also possible to control whether or not to transfer a vacuum pressure through a specific vacuum hole group. Accordingly, detailed shaping conditions, such as the size of the curvature of a curved surface to be shaped, can be adjusted.

As set forth above, the apparatus for shaping a glass substrate according to an embodiment of the present invention can shape a glass substrate (not shown) according to the areas thereof corresponding to vacuum hole groups by sequentially applying a vacuum pressure to the areas of the glass substrate (not shown) according to the vacuum hole groups. Consequently, after the shaping process, the glass substrate (not shown) can have a variety of 3D shapes, in which in which neither the number of curved surfaces nor the size of the curvature of the curved surfaces is restricted. That is, the apparatus for shaping a glass substrate according to an embodiment of the present invention can shape a glass substrate (not shown) to have a 3D shape according to a variety of 3D designs in which at least one edge portion of the four edges of the glass substrate is a curved surface.

The foregoing descriptions of specific exemplary embodiments of the present invention have been presented with respect to the drawings. They are not intended to be exhaustive or to limit the present invention to the precise forms disclosed, and obviously many modifications and variations are possible for a person having ordinary skill in the art in light of the above teachings.

It is intended therefore that the scope of the present invention not be limited to the foregoing embodiments, but be defined by the Claims appended hereto and their equivalents.

What is claimed is:

1. An apparatus for shaping a glass substrate, comprising:
a shaping frame;
a shaping recess disposed on one surface of the shaping frame;
a plurality of vacuum holes formed in the shaping frame to communicate with the shaping recess; and
a vacuum unit connected to the plurality of vacuum holes,
wherein the plurality of vacuum holes is divided into a plurality of vacuum hole groups corresponding to a plurality of areas of the shaping recess respectively, and
wherein the vacuum unit is independently connected to each of the plurality of vacuum hole groups to sequentially apply a vacuum pressure to each of a plurality of areas of the glass substrate when shaping the glass substrate.

2. The apparatus according to claim 1, wherein a common path is formed in the shaping frame, a common path communicating with the plurality of vacuum holes, and a partition is disposed in the common path to divide the plurality of vacuum hole groups from each other.

3. The apparatus according to claim 1, wherein at least one wall surface of the shaping recess comprises a curved surface such that at least one edge portion of four edges of the glass substrate is shaped to a curved surface.

4. The apparatus according to claim 3, wherein the plurality of vacuum hole groups includes a first vacuum hole group connected to a bottom of the shaping recess and a second vacuum hole group connected to at least one wall surface of the shaping recess.

5. The apparatus according to claim 4, wherein the vacuum unit is configured to perform first shaping on the glass substrate by applying a vacuum pressure to one area of the glass substrate that is to be a planar surface after being shaped through the first vacuum hole group, and subsequently, second shaping on the glass substrate by applying a vacuum pressure on another area of the glass substrate that is to form a curved surface after being shaped through the second vacuum hole group.
